(19) United States
(12) Patent Application Publication
(10) Pub. No.: US 2008/0084521 A1
(43) Pub. Date: Apr. 10, 2008

(54) Field sequentially driven liquid crystal display device

(75) Inventors: Takashi SUGIYAMA, Yokohama-shi (JP); Hiroshi TSUCHIHASHI, Yokohama-shi (JP); Osamu SUZUKI, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Stanley Electric Co., Ltd., Tokyo (JP)

(21) Appl. No.: 11/973,229

(22) Filed: Oct. 5, 2007

(30) Foreign Application Priority Data
Oct. 6, 2006 (JP) 2006-274730
Mar. 15, 2007 (JP) 2007-066255
Mar. 29, 2007 (JP) 2007-087912

(51) Int. Cl. G02F 1/1335

(52) U.S. Cl. 349/70

(57) ABSTRACT

A liquid crystal display device with improved visual recognition is provided which includes: a first liquid crystal cell; a second liquid crystal cell; two cross polarizers disposed on both sides of a two-layer structure panel including the first and second liquid-crystal cells along a normal direction of the substrates;

a light source capable of emitting lights of a plurality of colors; and a control circuit for time sequentially dividing one frame into a plurality of subframes, emitting light of a predetermined color in each subframe, synchronously with light emission, controlling a state of light transmission and light shielding of a plurality of display areas of said two-layer structure panel including said first and second liquid crystal cells, wherein the first and second liquid crystal cells are structured in a mutual optical compensation relation in both a driving state and a non-driving state.

### CROSS REFERENCE TO RELATED APPLICATION

This application is based on and claims priorities of Japanese Patent Applications No. 2006-274730 filed Oct. 6, 2006, No. 2007-066255 filed on Mar. 15, 2007 and No. 2007-087912 filed on Mar. 29, 2007, the entire contents of which are incorporated herein by reference.

### BACKGROUND OF THE INVENTION

A) Field of the Invention

The present invention relates to a liquid crystal display device, and more particularly to a field sequentially driven liquid crystal display device having a liquid crystal cell of a two-layer structure.

B) Description of the Related Art

In a liquid crystal display device, generally, displaying white characters and figures on a black background is called negative display, and displaying black characters and figures on a white background is called positive display.

A field sequential (FS) driving method is known as a method of driving a color liquid crystal display device which displays colors other than white on a black background and a color liquid crystal display device which-displays colors other than black on a white background.

According to the FS driving method, a light source capable of emitting lights of a plurality of colors is prepared, and color emission is sequentially repeated while turning on and off the liquid crystal display device synchronously with a light source emission timing, to thereby display lights of various colors on one display pixel by utilizing a time integration ability of human eyes.

A color liquid crystal display driven by the FS driving method is already known widely.

JP-A-2004-29154 (the entire contents of which are herein incorporated by reference) discloses a color liquid crystal display device which FS-drives a negative display liquid crystal cell using antiferroelectric liquid crystal.

JP-A-2004-294824 (the entire contents of which are herein incorporated by reference) discloses a negative display FS liquid crystal display device using-two twist nematic (TN) liquid crystal cells.

JP-A-2002-303846 (the entire contents of which are herein incorporated by reference) discloses a positive display FS liquid crystal display device using a homogeneous alignment liquid crystal cell.

### SUMMARY OF THE INVENTION

An object of the present invention is to provide an FS liquid crystal display device with improved visual recognition.

According to one aspect of the present invention, there is provided a liquid crystal display device comprising: a first liquid crystal cell including a first pair of opposing substrates and a first liquid crystal layer held between the first pair of substrates, the first pair of substrates having at least a first pair of pixel electrodes for displaying predetermined characters and figures, and an alignment state of the first liquid crystal layer being capable of being controlled by adjusting a voltage applied across the first pair of pixel electrodes; a second liquid crystal cell including a second pair of opposing substrates and a second liquid crystal layer held between the second pair of substrates, the second pair of substrates having a second pair of pixel electrodes for completely covering in area the predetermined characters and figures, and an alignment state of the second liquid crystal layer being capable of being controlled by adjusting a voltage applied across the second pair of pixel electrodes; two cross polarizers disposed on both sides of a two-layer structure panel including the first and second liquid crystal cells along a normal direction of the substrates; a light source capable of emitting lights of a plurality of colors; and a control circuit for time sequentially dividing one frame into a plurality of subframes, emitting light of a predetermined color in each subframe, synchronously with light emission, controlling a state of light transmission and light shielding of a plurality of display areas of the two-layer structure panel including the first and second liquid crystal cells, wherein the first and second liquid crystal cells are structured in a mutual optical compensation relation in both a driving state and a non-driving state.

According to another aspect of the present invention, there is provided a driving method for a liquid crystal display device comprising: a first liquid crystal cell including a first pair of opposing substrates and a first liquid crystal layer held between the first pair of substrates, the first pair of substrates having at least a first pair of pixel electrodes for displaying predetermined characters and figures, and an alignment state of the first liquid crystal layer being capable of being controlled by adjusting a voltage applied across the first pair of pixel electrodes; a second liquid crystal cell including a second pair of opposing substrates and a second liquid crystal layer held between the second pair of substrates, the second pair of substrates having a second pair of pixel electrodes for completely covering in area the predetermined characters and figures, and an alignment state of the second liquid crystal layer being capable of being controlled by adjusting a voltage applied across the second pair of pixel electrodes; two cross polarizers disposed on both sides of a two-layer structure panel including the first and second liquid crystal cells along a normal direction of the substrates; a light source capable of emitting lights of a plurality of colors; and a control circuit for time sequentially dividing one frame into a plurality of subframes, emitting light of a predetermined color in each subframe, synchronously with light emission, controlling a state of light transmission and light shielding of a plurality of display areas of the two-layer structure panel including the first and second liquid crystal cells, wherein the driving method controls in such a manner that a display area entered in the light shielding state in a subframe is made to enter in another subframe.

According to still another embodiment of the present invention, there is provided a driving method for a liquid crystal display device comprising: a first liquid crystal cell including a first pair of opposing substrates and a first liquid crystal layer held between the first pair of substrates, the first pair of substrates having at least a first pair of pixel electrodes for displaying predetermined characters and figures, and an alignment state of the first liquid crystal layer being capable of being controlled by adjusting a voltage applied across the first pair of pixel electrodes; a second liquid crystal cell including a second pair of opposing substrates and a second liquid crystal layer held between the second pair of substrates, the second pair of substrates having a second pair of pixel electrodes for completely covering in area the predetermined characters and figures, and an alignment state of the second liquid crystal layer being capable of being controlled by adjusting a voltage applied across the second pair of pixel electrodes; two cross polarizers disposed on both sides of a two-layer structure panel including the first and second liquid crystal cells along a normal direction of the substrates; a light source capable of emitting lights of a plurality of colors; and a control circuit for time sequentially dividing one frame into a plurality of subframes, emitting light of a predetermined color in each subframe, synchronously with light emission, controlling a state of light transmission and light shielding of a plurality of display areas of the two-layer structure panel including the first and second liquid crystal cells, wherein the driving method controls in such a manner that gradation display is performed by controlling the alignment state of the liquid crystal of at least one of the first and second liquid crystal cells to have an intermediate alignment state between the driving state and non-driving state.

According to the FS liquid crystal display device of the present invention, visual recognition can be improved.

### BRIEF DESCRIPTION OF THE DRAWINGS

FIG. 1 is a schematic cross sectional view of a liquid crystal display unit having a two-layer structure.

FIG. 2 is a diagram showing the transmission axis directions of polarizing plates and the rubbing directions of liquid crystal cells of the liquid crystal display unit.

FIG. 3 is a schematic block diagram of an FS liquid crystal display device equipped with the liquid crystal display unit.

FIG. 4A is a diagram showing transparent electrodes mounted on a back liquid crystal cell of the liquid crystal display unit, and FIG. 3B is a diagram showing transparent electrodes mounted on a front liquid crystal cell of the liquid crystal display unit.

FIG. 5A is an illustrative diagram of the transparent electrodes of the back liquid crystal cell used segment display electrodes, and FIG. 5B is an illustrative diagram of the transparent electrodes of the front liquid crystal cell used as background electrodes.

FIG. 6 is an illustrative diagram showing a color display state.

FIG. 7 is a table illustrating a driving method for a liquid crystal display device according to embodiment 1-1.

FIG. 8 is a table illustrating a driving method for a liquid crystal display device according to embodiment 1-2.

FIG. 9 is a table illustrating a driving method for a liquid crystal display device according to embodiment 1-3.

FIG. 10 is a table illustrating a driving method for a liquid crystal display device according to embodiment 1-4.

FIG. 11 is a table illustrating a driving method for a liquid crystal display device according to embodiment 1-5.

FIG. 12 is a table illustrating a driving method for a liquid-crystal display device according to embodiment 1-5.

FIGS. 13A and 13B are diagrams showing examples of electrode patterns of two liquid crystal cells.

FIG. 14 is a table illustrating a driving method for a liquid crystal display device according to embodiment 2-1.

FIG. 15 is an illustrative diagram showing a color display state.

FIG. 16 is a table illustrating a driving method for a liquid crystal display device according to embodiment 2-2.

FIG. 17 is an illustrative diagram showing a color display state.

FIG. 18 is a table illustrating a driving method for a liquid crystal display device according to embodiment 2-3.

FIG. 19 is an illustrative diagram showing a color display state.

FIGS. 20A and 20B are diagrams showing examples of electrode patterns of two liquid crystal cells.

FIG. 21 is a diagram illustrating gradation display.

FIG. 22 shows a display example according to embodiment 3-1.

FIG. 23 is a table illustrating a driving method for a liquid crystal display device according to the embodiment 3-1.

FIG. 24 shows a display example of embodiment 3-2.

FIG. 25 is a table illustrating a driving method for a liquid crystal display device according to the embodiment 3-2.

FIGS. 26A and 26B show examples of a projection type display device adopting the embodiment.

FIG. 27 is a diagram showing the transmission axis directions of polarizing plates and the rubbing directions of liquid crystal cells of a liquid crystal display unit of a two-layer structure using vertically aligned liquid crystal cells.

### DESCRIPTION OF THE PREFERRED EMBODIMENTS

Embodiments of the present invention will be described with reference to the accompanying drawings.

### Embodiment 1

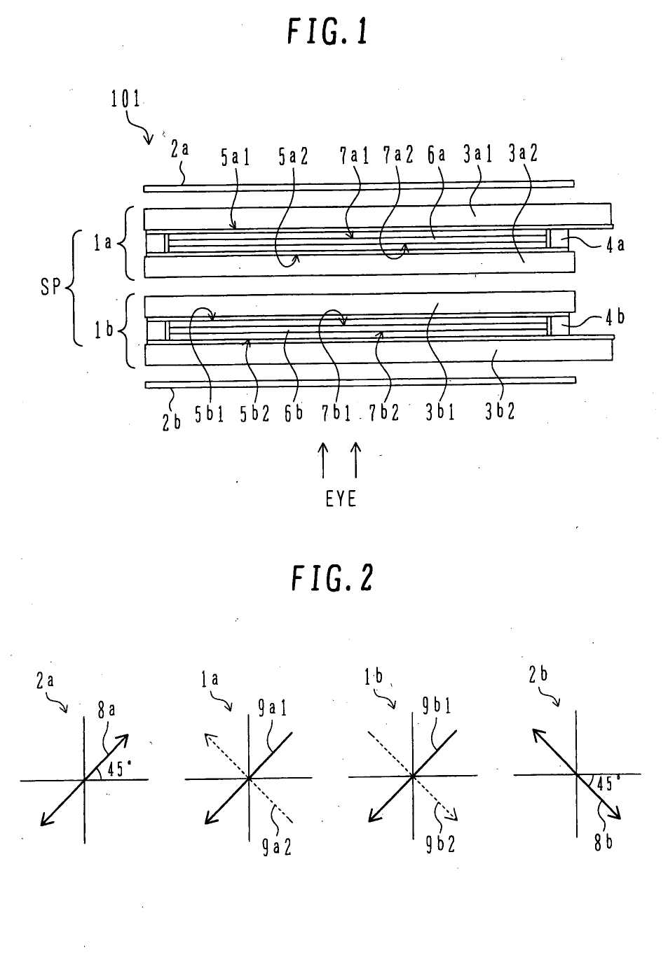

FIG. 1 is a schematic cross sectional view showing an example of the structure of a liquid crystal display unit equipped in a liquid crystal display device.

The liquid crystal display unit is constituted of a front liquid crystal cell 1b, a back liquid crystal cell 1a, a front polarizing plate (polarizer) 2b and a back polarizing plate 2a.

A spacer is provided between the front liquid crystal cell 1b and back liquid crystal cell 1a to couple them together. The front polarizing plate 2b is adhered to the front liquid crystal cell 1b, and the back polarizing plate 2a is adhered to the back liquid crystal cell 1a. We call the coupled two TN liquid crystal cells a two-layer structure panel SP.

As shown, the front liquid crystal cell 1b sandwiches liquid crystal 6b by a pair of transparent substrates (e.g., glass substrates) 3b1 and 3b2 having transparent electrodes 5b1 and 5b2 formed thereon.

The transparent electrodes 5b1 and 5b2 have alignment films 7b1 and 7b2 on the opposing surfaces of the electrodes.

A seal member 4b is used for adhering the peripheral areas of the transparent substrates 3b1 and 3b2 with adhesive to thereby seal the liquid crystal 6b in the space between the transparent substrates 3b1 and 3b2.

Similar to the front liquid crystal cell 1b, the back liquid crystal cell 1a is constituted of a pair of transparent substrates (e.g., glass substrates) 3a1 and 3a2 adhered together by a seal member 4a with adhesive and sealing liquid crystal 6a therebetween, transparent electrodes 5a1 and 5a2 formed on the transparent substrates 3a1 and 3a2, and alignment films 7a1 and 7a2 formed on the opposing surfaces of the transparent electrodes 5a1 and 5a2.

FIG. 2 is a diagram showing the transmission axis directions of polarizing plates and the rubbing directions of liquid crystal cells of the liquid crystal display unit.

Namely, a rubbing direction 9b2 is used for the front alignment film 7b2 of the front liquid crystal cell 1b, and a rubbing direction 9b1 is used for the back alignment film 7b1 of the front liquid crystal cell 1b. A rubbing direction 9a2 in FIG. 2 is used for the front alignment film 7a2 of the back liquid crystal cell 1a, and a rubbing direction 9a1 in FIG. 2 is used for the back alignment film 7a1 of the back liquid crystal cell 1a.

The front liquid crystal cell 1b is formed as a TN type liquid crystal cell. The alignment films 7b1 and 7b2 are made of horizontally aligned films SE-410 manufactured by Nissan Chemical Industries, Ltd. By rubbing the alignment films along the directions in FIG. 2 with a rubbing cloth made of rayon, a pretilt angle is given.

The transparent substrates 3b1 and 3b2 are stacked and adhered with adhesive, with a gap control member having a diameter of 5 μm being interposed therebetween. The liquid crystal 6b sealed in the space between the transparent substrates 3b1 and 3b2 is made of liquid crystal material having positive dielectric constant anisotropy (liquid crystal molecules rise from a horizontal twist alignment upon voltage application) and a birefringence Δn of 0.95, manufactured by Merck Ltd, with chiral material for determining a twist direction being added.

The back liquid crystal cell 1a has the structure similar to that of the front liquid crystal cell 1b, except that chiral material for setting a clockwise twist direction is used for the front liquid crystal cell 1b, whereas chiral material for setting a counter-clockwise twist direction is used for the back liquid crystal cell 1a.

The front liquid crystal cell 1b and back liquid crystal cell 1a have a mutual optical compensation relation because the cells have opposite twist directions and the rubbing direction 9b1 for the back alignment film 7b1 of the front liquid crystal cell 1b is perpendicular to the rubbing direction 9a2 for the front alignment film 7a2 of the back liquid crystal cell 1a, as indicated in FIG. 2.

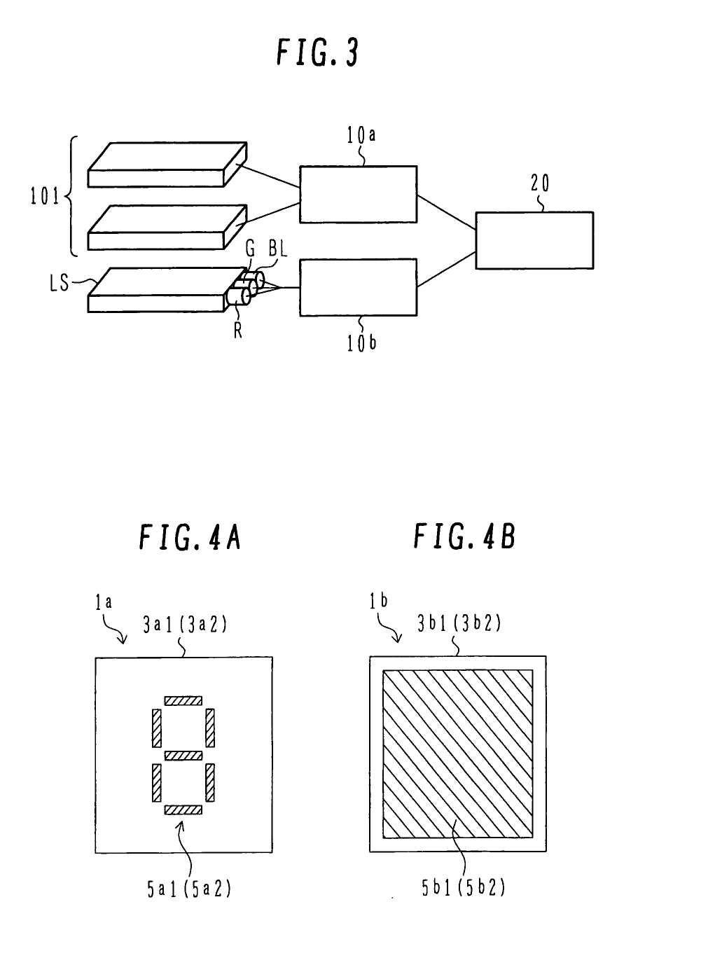

FIG. 3 is a block diagram showing an FS liquid crystal display device of the embodiment. In FIG. 3, the front and back polarizing plates 2b and 2a are not shown.

As shown in FIG. 3, on the back side of the back liquid crystal cell 1a, a back light LS is disposed which sequentially emits lights of red (R), green (G) and blue (B).

A driver 10b for the back light LS operates synchronously with a driver 10a for the two liquid crystal cells 1b and 1a under control of a sync controller 20.

The back light LS may be a well-known light source constituted of a light emitting diode (LED), a cold cathode fluorescent lamp (CCFL) or the like. The FS driving method may be the method described in JP-A-2004-29154, JP-A-2004-294824 and JP-A-2002-303846, excepting that the liquid crystal unit of a two-layer structure is used. Similar to the liquid crystal display device described in these Publications, one frame period is the sequentially divided into a plurality of subframes, the back light LS is driven to emit light in each subframe, and synchronously with this emission, the electrodes of the front liquid crystal cell 1b and back liquid crystal cell 1a are driven to turn on and off.

The front liquid crystal cell 1b and back liquid crystal cell 1a have transparent electrodes shown in FIGS. 4A and 4B.

Namely, the transparent electrodes 5a1 and 5a2 of the back liquid crystal cell 1a are segment electrodes shown in. FIG. 4A.

More specifically, the transparent electrodes 5a1 and 5a2 are general display electrodes for displaying characters and figures.

The transparent electrodes 5b1 and 5b2 are background display electrodes shown in FIG. 4B.

More specifically, the transparent electrodes 5b1 and 5b2 of the front liquid crystal cell 1b are background display electrodes for displaying, so-called solid-displaying, the whole effective display area inside the seal member 4b.

The segment electrodes may be formed on the front liquid crystal cell 1b, and the background display electrodes may be formed on the back liquid crystal cell 1a.

Next, color display examples of the liquid crystal display device will be described.

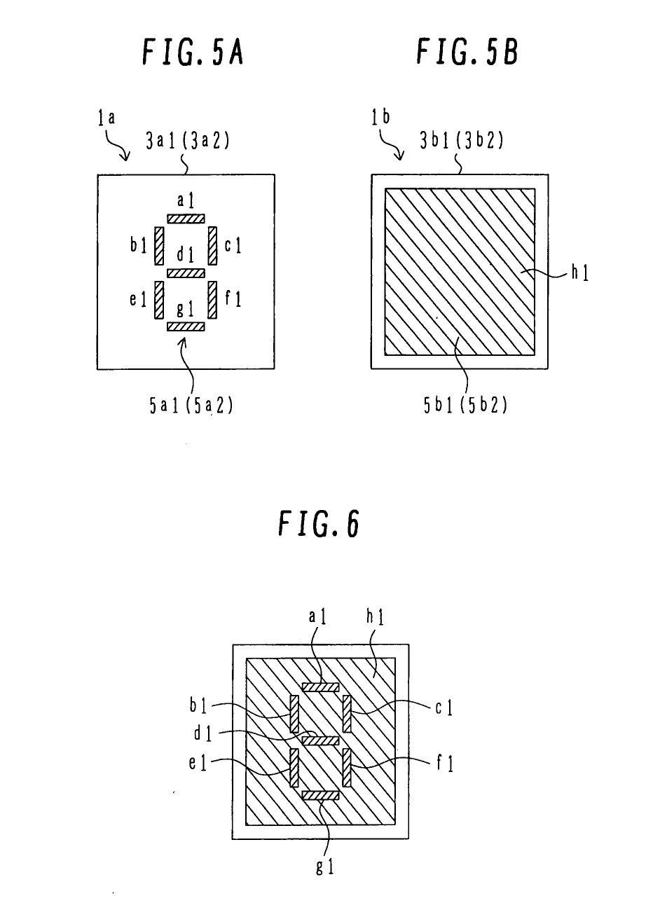

For the purposes of description simplicity, it is assumed that the transparent electrodes 5b1 and 5b2 of the front liquid crystal cell 1b are the background display electrodes and that the transparent electrodes 5a1 and 5a2 of the back liquid crystal cell 1a are seven-segment electrodes. Electrodes of the seven-segment electrode are affixed alphabets a1 to h1 as shown in FIG. 5A and 5B.

If an intermediate luminance is not considered, the back light LS for emitting lights of three colors R, G and B can emit eight color lights including white and black. Description will therefore be made on display examples assigning seven color lights to seven segment electrodes a1 to g1 and one color light to the background display electrodes h1.

In actual display, not only numbers including “8” is displayed by using seven colors, but also a variety of color images are displayed by using a number of segments.

### Embodiment 1-1

In the first display configuration example, color display is performed on a black underlying screen, which is a typical example of negative display. In FIG. 6 the background display electrode h1 is used for black display, the segment electrode a1 is used for white display, the electrode b1 is used for yellow display, the electrode c1 is used for magenta display, the electrode d1 is used for red display, the electrode e1 is used for cyan display, the electrode f1 is used for green display, and the electrode c1 is used for blue display.

In this display configuration example, color display is performed by driving the segment electrodes and background electrodes to turn and off at emission timings of LED's of R, G and B of the back light LS, as shown in FIG. 7.

The feature of the first display configuration example resides in that the background is maintained black by setting the background display electrodes h1 in an OFF state even at the emission timings of each LED of R, G and B, and each segment electrode is driven to turn on and off synchronously with the emission timing of each LED, to thereby perform display of seven colors.

An ON state of each electrode is a state that a voltage sufficient for white display is applied to liquid crystal of the two liquid crystal cells 1b and 1a each operating as a general TN cell having parallel Nicol polarizing plates on both sides thereof. An OFF state of each electrode is a state that a voltage is not applied in the case of static driving and that a sufficient voltage for black display is applied in the case of multiplex driving to liquid crystal of the two liquid crystal cells 1b and 1a each operating as a general TN cell having parallel Nicol polarizing plates on both sides thereof.

### Embodiment 1-2

In the second display configuration example, color display is performed on a white background, which is a typical example of positive display. In FIG. 6 the background display electrode h1 is used for white display, the segment electrode a1 is used for black display, the electrode b1 is used for blue display, the electrode c1 is used for green display, the electrode d1 is used for cyan display, the electrode e1 is used for red display, the electrode f1 is used for magenta display, and the electrode g1 is used for yellow display.

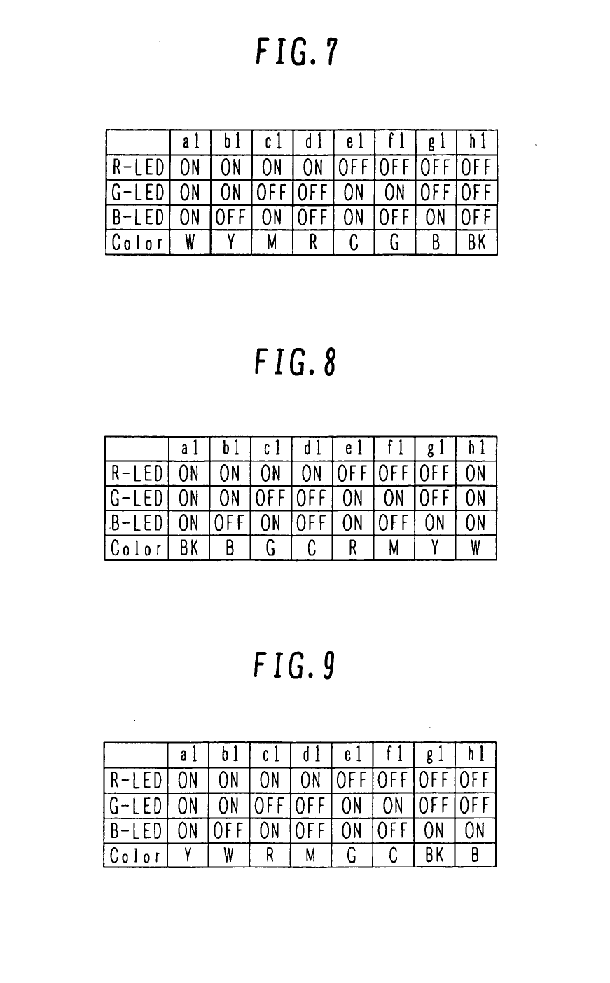

In this display configuration example, color display is performed by driving the segment electrodes and background electrodes to turn on and off at emission timings of LED's of R, G and B of the back light LS, as shown in FIG. 8.

The feature of the second display configuration example resides in that the background is maintained white by setting the background display electrodes h1 in an ON state even at the emission timing of each LED of R, G and B, and each segment electrode is driven to turn on and off synchronously with the emission timing of each LED, to thereby perform display of seven colors. The definition of the ON and OFF states of each electrode is the same as that of the first display configuration example.

It is often thought that color display cannot be performed because the segment electrodes a1 to g1 are influenced by the background display electrodes h1 in the ON state. However, if the segment electrode is driven to turn on at the same timing as that the background display electrodes are driven to turn on, black display can be performed because of mutual optical compensation of the two liquid crystal cells 1b and 1a.

For example, the segment electrode a1 is driven to turn on at the emission timing of each LED of R, G and B relative to the background display electrodes h1.

Similarly, emission light of each of the other segment electrodes is shielded if the segment electrode is in the same state as that of the background display electrodes h1 at the emission timing, i.e., in the ON state, and transmitted if the segment electrode is a different state from that of the background display electrodes h1 at the emission timing, i.e., in the OFF state. In this manner, display of seven colors on the white background is realized.

### Embodiment 1-3

In the third display configuration example, background color is color different from white and black, and is one of R, G and B of the back light LS.

For example, assuming that ON and OFF timings of emission the back light LS and the electrodes a1 to h1 are set as shown in FIG. 9, in FIG. 6 the background display electrodes h1 are used for blue display, the segment electrode a1 is used for yellow display, the electrode b1 is used for white display, the electrode c1 is used for red display, the electrode d1 is used for magenta display, the electrode e1 is used for green display, the electrode f1 is used for cyan display, and the electrode g1 is used for black display.

### Embodiment 1-4

In the fourth display configuration example, background color is mixed color of two colors of R, G and B.

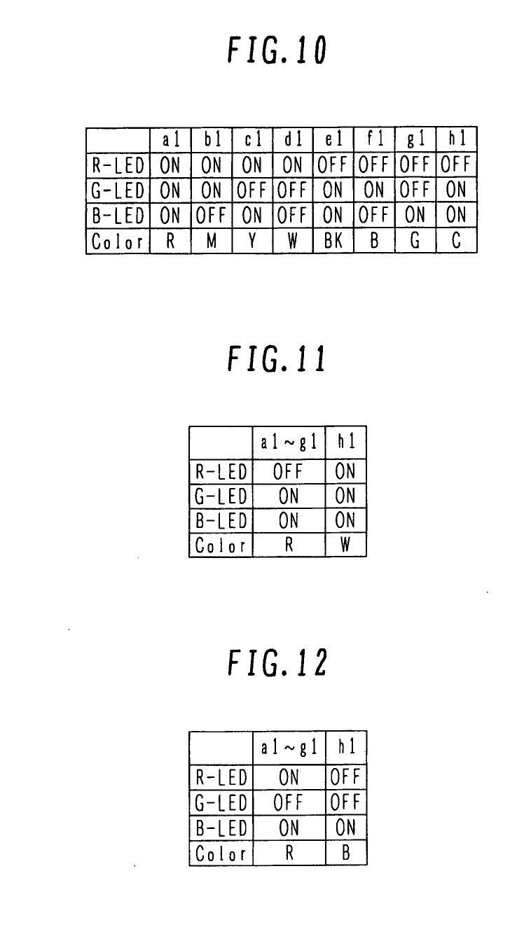

For example, assuming that ON and OFF timings of emission of the back light LS and the electrodes a1 to h1 are set as shown in FIG. 10, in FIG. 6 the background display electrodes h1 are used for cyan display, the segment electrode a1 is used for red display, the electrode b1 is used for magenta display, the electrode c1 is used for yellow display, the electrode d1 is used for white display, the electrode e1 is used for black display, the electrode f1 is used for blue display, and the electrode g1 is used for green display.

### Embodiment 1-5

In the fifth display configuration example, background color is changed without changing a display color by the segment electrodes.

For example, assuming that ON and OFF timings of emission and the back light LS and the electrodes a1 to h1 are set as shown in FIG. 11, in FIG. 6 the background display electrodes h1 are used for white display, and all the segments a1 to g1 are used for red display, i.e., segment display is a number “9” in red. Assuming that ON and OFF timings of emission the back light 31 and the electrodes a1 to h1 are set as shown in FIG. 12, the background color can be changed to blue without changing the red segment display.

As seen from FIG. 11 and FIG. 12, the segment electrodes a1 to g1 and background display electrodes h1 operate to provide different display states only at the timing when LED of color to be displayed emits light.

### Embodiment 2

Inventors created the liquid crystal display in which a so-called color break phenomenon do not occur by changing a FS driving way.

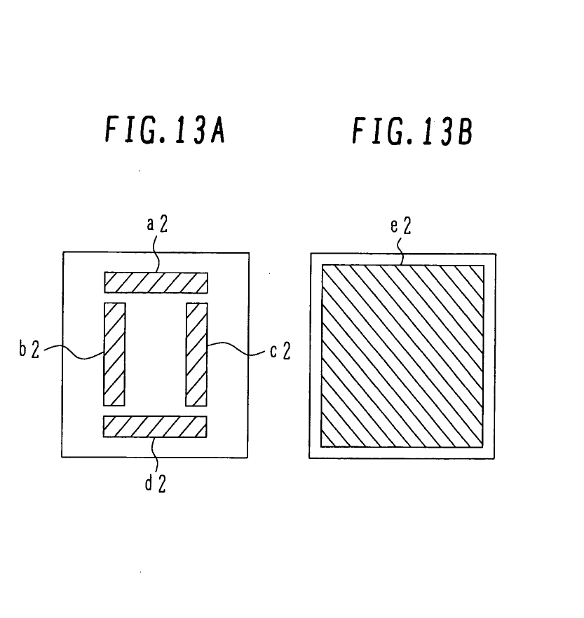

FIG. 13 shows an example of the electrode patterns of the two liquid crystal cells in the embodiment 2. The liquid crystal cells 1a and 1b have transparent electrodes for display upon voltage application to the liquid crystal layers. One cell (called a display cell) has segment electrodes such as electrodes a2 to d2 shown in FIG. 13 for segment display, and the other cell (called a background display cell) has rigid electrodes e2 for displaying the whole effective display area. Either the display cell or the background display cell may be disposed upper (on the back side).

Embodiments will be described in which one frame of a drive voltage is divided into three subframes.

### Embodiment 2-1

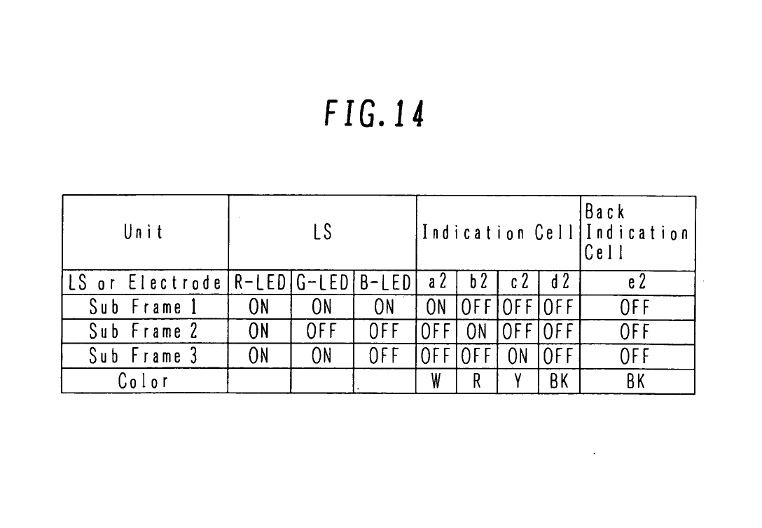

FIG. 14 shows a table illustrating a driving method for a liquid crystal display device according to the first embodiment. In embodiment 2-1, color segment display is performed on a black background, which is typical negative display. The table shown in FIG. 14 shows an ON/OFF state of each LED of R, G and B in each subframe, an ON/OFF state of the segment electrodes a2 to d2 on the display cell and the rigid electrodes e2 on the background display cell, and each color displayed in the display area defined by each electrode. The rigid electrode e2 is larger than the segment electrodes a2 to d2 and is formed covering almost the whole display area, so that the segment electrodes a2 to e2 are superposed upon the display area. A display color for the electrode e2 is a background display color other than the colors for the segment electrodes.

An ON state of LED corresponds to an emission state, and an OFF state corresponds to a nonemission state. A definition of ON state and OFF state is similar with the embodiment 1.

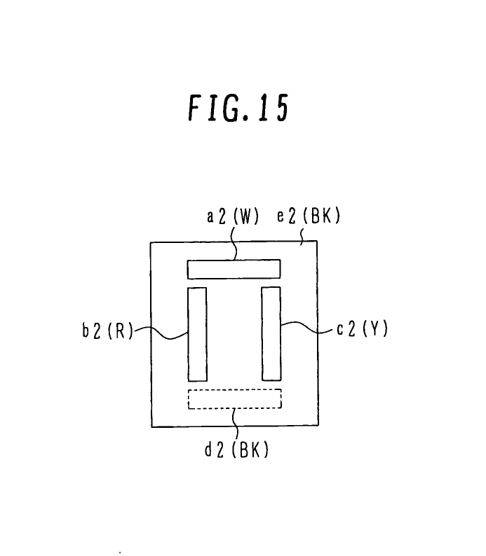

FIG. 15 shows an example of actual display. In the embodiment 2-1, the rigid electrodes e2 are set to the OFF state in all subframes to perform black display of the background (not superposed upon the segment electrodes a2 to e2). The ON or OFF state is set to the segment electrodes a2 to e2 in accordance with each subframe. In the display area where the rigid electrodes e2 of the background display cell are superposed upon each of the segment electrodes a2 to d2 of the display cell, the liquid crystal display unit enters the light transmission state if one of the cells is ON, whereas the liquid crystal display unit enters the light shielding state if both the cells are ON or OFF.

In each subframe, LED emits light of its display color. It is possible to emit lights of a plurality of colors by adjusting ON/OFF and emission intensity of R, G and B. In the table shown in FIG. 14, ON/OFF of voltage is controlled so that the electrode a is used for white (W) display, the electrode b is used for red (R) display, the electrode c is used for yellow (Y) display, and the electrode d is used for black (BK) display, as shown in FIG. 15.

### Embodiment 2-2

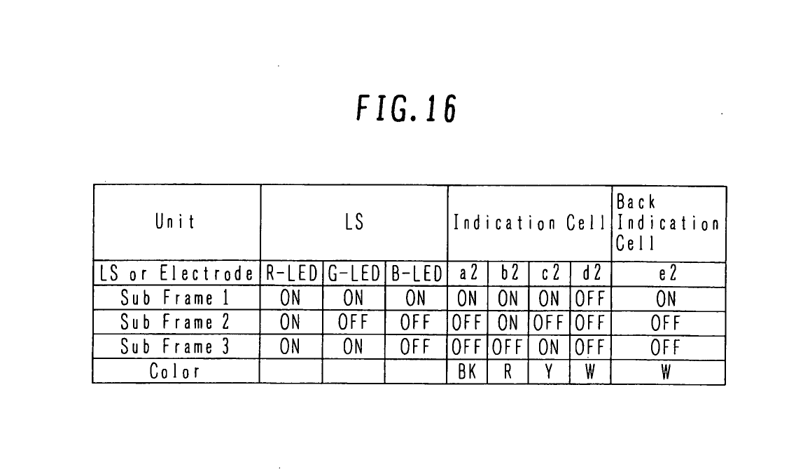

FIG. 16 shows a table illustrating a driving method for a liquid crystal display device according to the second embodiment. In the embodiment 2-2, color segment display is performed on a white background, which is typical positive display. The definitions of ON/OFF of LED and ON/OFF of each electrode are similar to those of the embodiment 2-1.

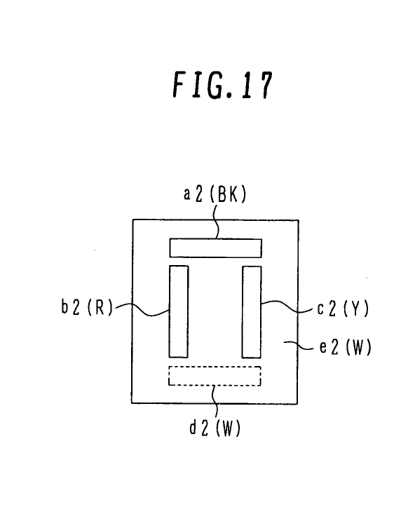

FIG. 17 shows an example of actual display. In the second embodiment, in a subframe while the back light emits white light, the rigid electrodes e2 are set to the ON state to perform white display of the background. The control method for the light transmission/light shielding state for the liquid crystal display unit is similar to the embodiment 2-1.

If the rigid electrodes (e2) are in the ON state, it is considered that there is a possibility of the color break phenomenon of segment display by the influence of display by the electrodes (e2), in the display area where the rigid electrodes e2 are superposed upon any one of the segment electrodes a2 to d2. The present inventors have found that the color break phenomenon can be prevented by shielding emission light of the back light in the superposed electrode area by setting the ON state to the electrode for displaying color other than white among the segment electrodes a to d, in the subframe while the electrodes e are set to the ON state. For example, since the electrode a2 has the same ON/OFF state as that of the electrode e in all subframes, black display (light shielding state) is preformed.

If another color is desired to be displayed, in the subframe while light of this color is emitted from the back light, the drive voltage is set to the state different from the electrode e2 (one is the ON state and the other is the OFF state).

In the table shown in FIG. 16, ON/OFF of voltage is controlled so that the electrode a2 is used for black (BK) display, the electrode b2 is used for red (R) display, the electrode c2 is used for yellow (Y) display, and the electrode d2 is used for white (W) display, as shown in FIG. 17. Similar to the first embodiment, it is possible to emit lights of a plurality of colors other than the colors shown in the table, by adjusting ON/OFF and emission intensity of LED of R, G and B.

### Embodiment 2-3

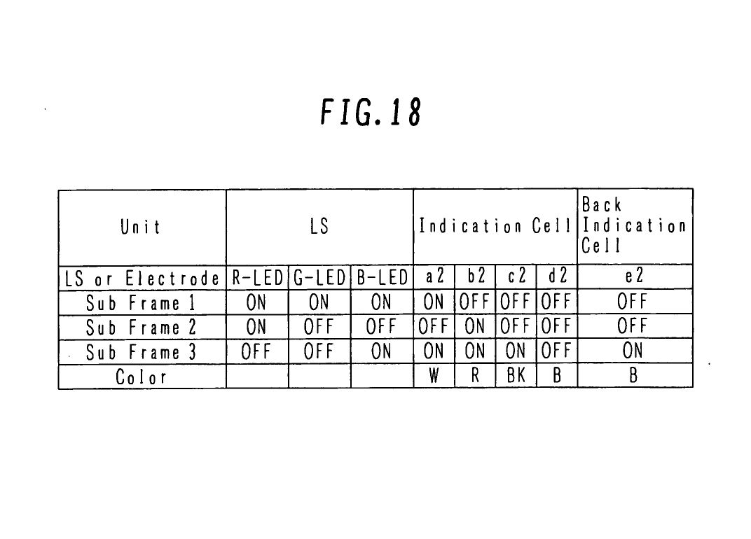

FIG. 18 shows a table illustrating a driving method for a liquid crystal display device according to the third embodiment. In embodiment 2-3, color segment display is performed on a background of desired color. The definitions of ON/OFF of LED and ON/OFF of each electrode are similar to those of the embodiment 2-1.

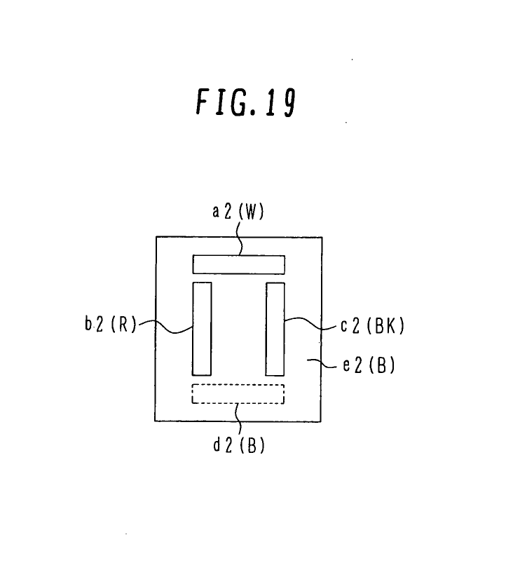

FIG. 19 shows an example of actual display. In FIG. 19, blue display is used for the background color. In a subframe while the back light emits blue light, the ON state is set to the electrode e. The control method for the light transmission/light shielding state for the liquid crystal display unit is similar to embodiment 2-1.

The color break phenomenon can be prevented in the manner similar to embodiment 2-2.

In the table shown in FIG. 18, ON/OFF of voltage is controlled so that the electrode a2 is used for white (W) display, the electrode b2 is used for red (R) display, the electrode c2 is used for black (BK) display, and the electrode d2 is used for blue (B) display, as shown in FIG. 19. Similar to the first embodiment, it is possible to emit lights of a plurality of colors other than the colors shown in the table, by adjusting ON/OFF and emission intensity of LED of R, G and B.

As the embodiment 2 described above, in the area where the electrodes of the two liquid crystal cells of the liquid crystal display unit 101 are superposed, it is possible to shield light from the back light, even if the drive voltages of both the liquid crystal cells are not only in the OFF state but also in the ON state. It is therefore possible to provide a multi color liquid crystal display device capable of preventing color break and display shift and improving the display quality.

Since the display brightness can be adjusted by the back light, a voltage applied to the liquid crystal cell can be determined under the condition (all ON/all OFF) that the response speed becomes maximum, and there is a merit that it is not necessary to perform gradation display which lowers considerably a response speed of liquid crystal.

### Embodiment 3

Inventors created a liquid crystal display that is capable of multi-color displaying and do not occur color break phenomenon.

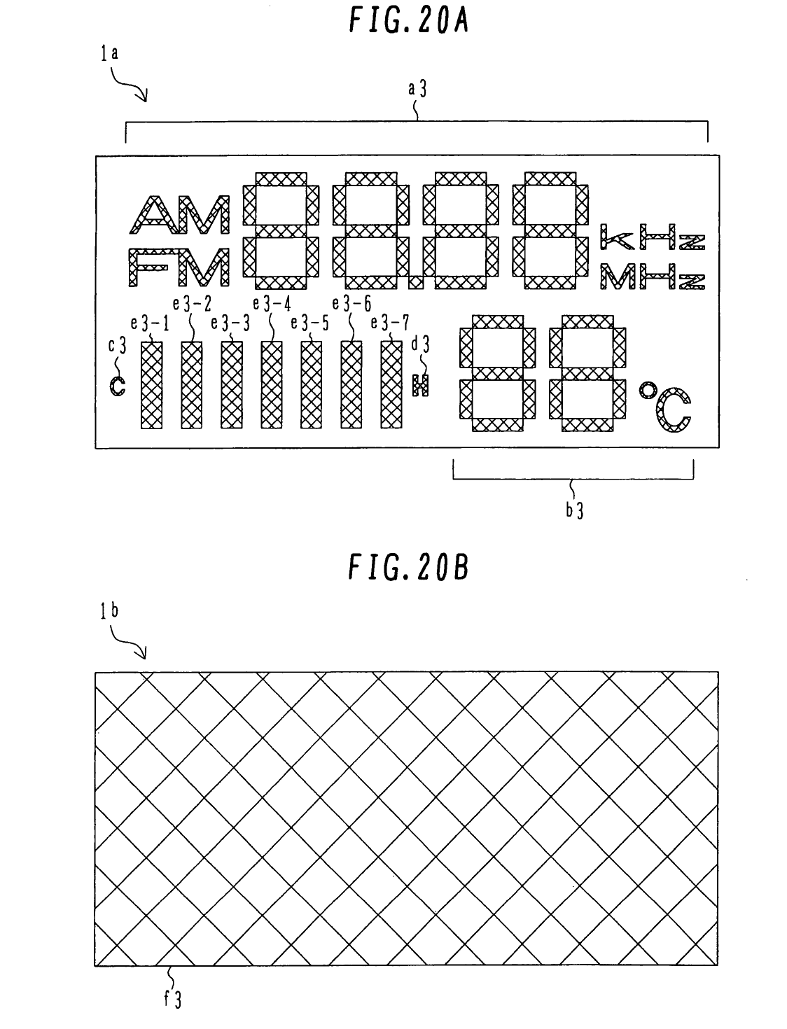

FIGS. 20A and 20B show an example of the electrode patterns of the two liquid crystal cells. The liquid crystal cells 1a and 1b have transparent electrodes for display upon voltage application to the liquid crystal layers. One cell (called a display cell) has segment electrodes such as electrodes a3 to d3 and e3-1 to e3-7 shown in FIG. 3A for segment display, and the other cell (called a background display cell) has a rigid electrodes f for displaying the whole effective display area. Either the display cell or the background display cell may be disposed upper (on the back side).

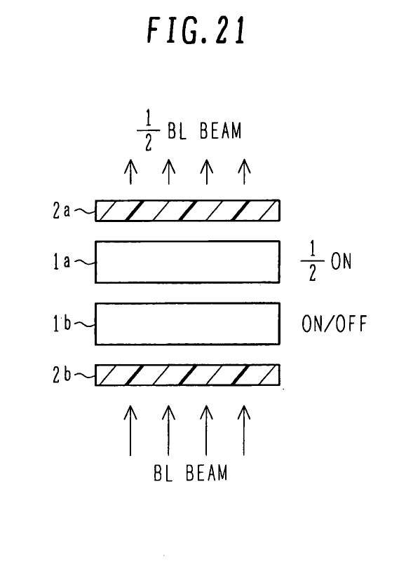

FIG. 21 is a conceptual diagram illustrating gradation display. In the embodiment, an example of simple control is used in which while the background display cell is set in the driving state or non-driving state, a voltage to be applied to the display cell is controlled to realize gradation display at a desired tone. If gradation display is not performed, the liquid crystal display unit enters the light transmission state by setting the background display cell 1b to the ON (or OFF) state and the display cell to the OFF (or ON) state. In this embodiment, by adjusting a voltage to be applied to the display cell, light from the back light to be transmitted is adjusted to thereby perform gradation display. In the example shown in FIG. 21, in order to allow a half of light from the back light to be transmitted, the background display cell is set to the ON (or OFF) state and the display cell is set to the ON (or OFF) state. In the embodiment, a voltage application state for gradation display is represented by O/OON (O/O is a tone ratio for gradation display). Embodiments will be described in which one frame of a drive voltage is divided into three subframes.

### Embodiment 3-1

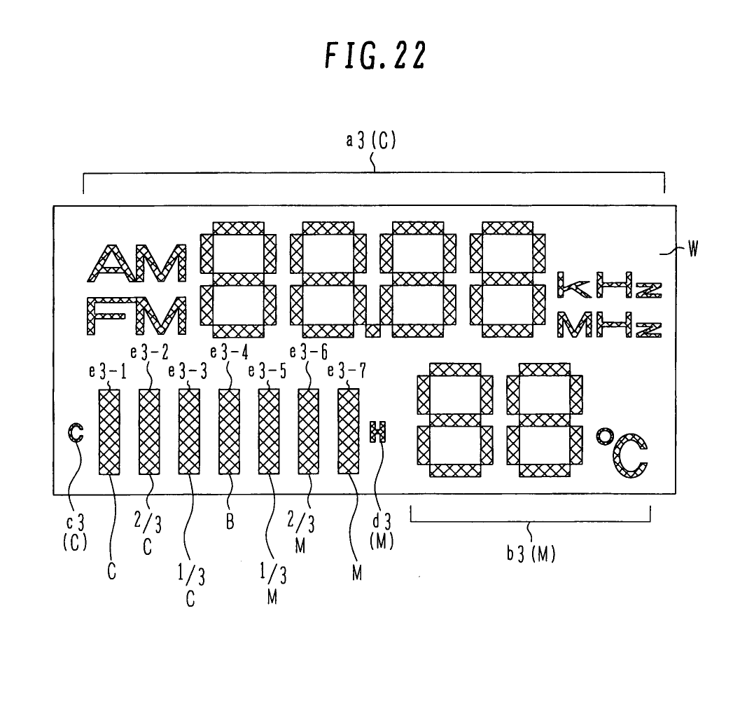

FIG. 22 shows a display example. In embodiment 3-1, segment display is performed on a white background. In embodiment 3-1, color segment display is performed on a black background, which is typical positive display. The rigid electrode f3 is larger than each of the segment electrodes and is formed covering almost the whole display area. The segment electrodes in a table shown in FIG. 7 constitute display areas. Display color of the electrode f3 in the table is a color of the background display area other than the display areas defined by the segment electrodes. A color density is expressed, for example, by affixing a fraction before the color name, such as ½ blue if a blue density is a half of a normal density. Settings in the embodiment 3-1 are a3-cyan, b3-magenta, (density display is possible in accordance with a temperature), c3-cyan, d3-magenta, e3-1-cyan, e3-2-⅔ cyan, e3-3⅓ cyan, e3-4-black, e3-5-⅓ magenta, e3-6-⅔ magenta, e3-7-magenta, and f3-white.

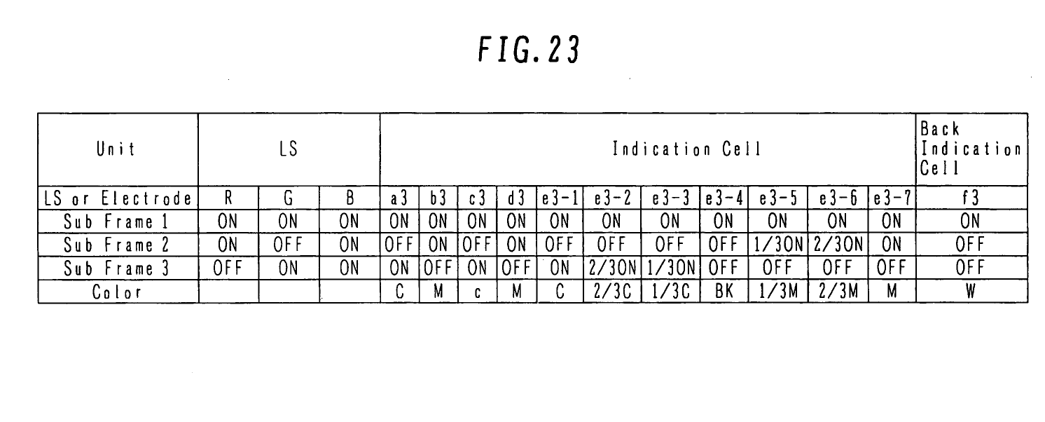

FIG. 23 shows the table illustrating the driving method for the liquid crystal display device of the embodiment 2. The table shown in FIG. 23 shows an ON/OFF state of each LED of R, G and B in each subframe, an ON/OFF state of the segment electrodes a3 to d3 and e3-1 to e3-7 on the display cell and the rigid electrodes f3 on the background display cell, and each color displayed in the display area defined by each electrode. An ON state of LED corresponds to an emission state and an OFF state corresponds to a non-emission state. An ON state of each electrode corresponds to the driving state and an OFF state corresponds to the non-driving state.

The embodiment 3-1 uses the TN liquid crystal cells. If the two TN liquid crystal cells having opposite twist directions are both in the OFF state, both the cells cancel optical twists so that the liquid crystal display unit having the cross polarizers enters the light shielding state. If the two cells are both in the ON state, liquid crystal molecules of the cells vertically rise so that light transmits through the liquid crystal cells without any twist and the liquid crystal display unit having the cross polarizers enters the light shielding state. If one of the cells is in the ON state, light transmits through the cell in the ON state without any twist and light twists by 90° in the cell in the OFF state. The liquid crystal display unit therefore enters the light transmission state. In the embodiment, although opposite twist directions are used to obtain optimum view angle characteristics, it is expected that the same twist direction may also be used.

In each subframe, LED emits light of a corresponding color. It is possible to emit lights of a plurality of colors by adjusting the ON/OFF state and emission intensity of each LED of R, G and B.

In a subframe while the back light emits light of white color, all segment electrodes and rigid electrodes f are set to the ON state to thereby perform white display of the background (an area not superposed upon the segment electrode). Each segment is assigned either the ON or OFF state in accordance with each subframe. In the display areas where the rigid electrodes f of the background display cell superpose upon each segment electrode of the display cell, if one of the cells is in the ON state, the liquid crystal display unit enters the light transmission state. If both the cells are in the ON or OFF state, the liquid crystal display unit enters the light shielding state. If color densities for the electrodes b3, e3-2, e3-3, e3-5, e3-6 and the like are to be set (e.g., if an air conditioner temperature is to be expressed by a color density), a driving waveform having an effective voltage capable of gradation display is applied across the segment electrodes. The effective voltage of the driving waveform can be controlled by adjusting an ON voltage, by pulse control of time sequentially dividing an ON waveform, or other methods.

As seen from the table shown in FIG. 23, the color break-less liquid crystal display device with controlled liquid crystal cells and back light can emit lights of a plurality of colors in excess of the subframe division number and eliminate the display problem such as color loss and discoloration due to parallax and duplicate imaging, more than when gradation display is not performed.

### Embodiment 3-2

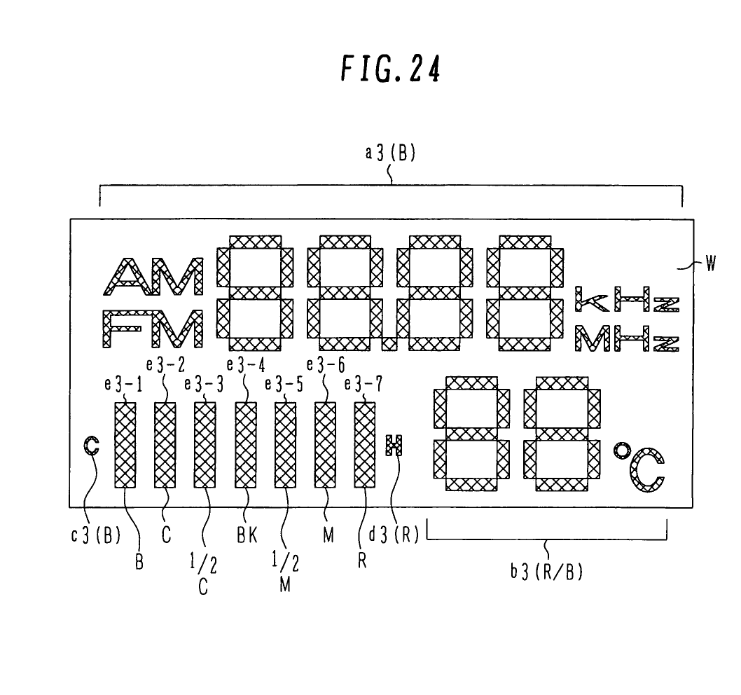

FIG. 24 shows a display example. In embodiment 3-2, color segment display is performed on a black background, which is typical positive display. The definitions of the ON/OFF state of LED and the ON/OFF state of each electrode are similar to those of the embodiment 3-1. In the embodiment 3-2, the number of colors larger than that of the first embodiment can be displayed by a time sequential division color mixture method. It is, however, to be noted that this embodiment is used under the condition that the color break phenomenon is permitted.

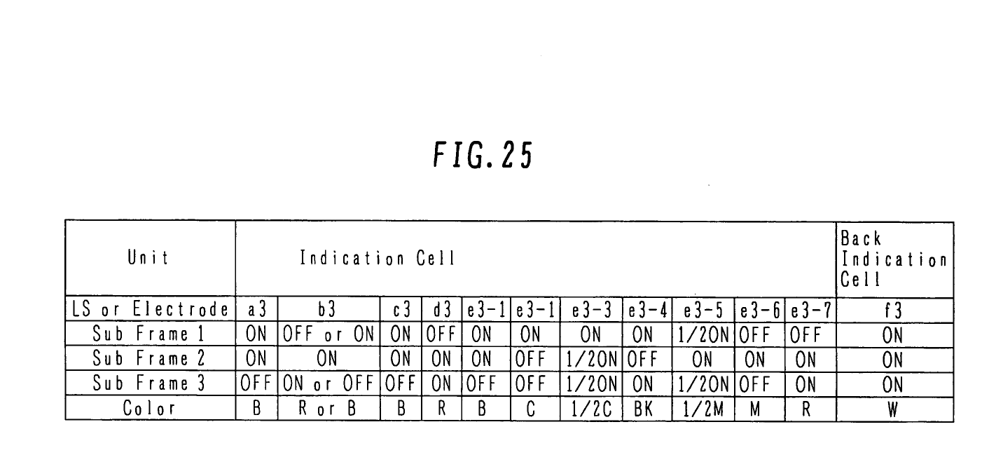

FIG. 25 shows a table illustrating the driving method for the liquid crystal display device of the second embodiment. As shown in FIG. 9, settings in the second embodiment are a3-blue, b3-red or blue (density display is possible in accordance with a temperature), c3-blue, d3-red, e3-1-blue, e3-2-cyan, e3-3-½ cyan, e3-4-black, e3-5-½ magenta, e3-6-magenta, e3-7-red, and f-white. It is possible to display the number of colors larger than that of the embodiment 3-1.

As described earlier, the liquid crystal display unit 101 can shield light from the back light in the display area where the electrodes of the two liquid crystal cells are superposed, in the case where the driving voltages of both the liquid crystal cells are not only in the OFF state but also in the OFF state. It is therefore possible to provide a multi color liquid crystal display device capable of preventing display shift and the like and improving the display quality.

It is also possible to provide a liquid crystal display device capable of displaying a number of colors by controlling the liquid crystal cells to be able to perform gradation display.

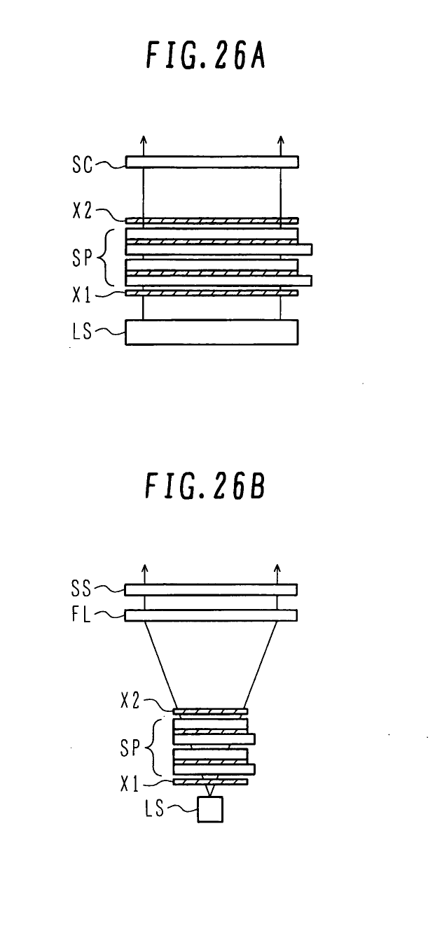

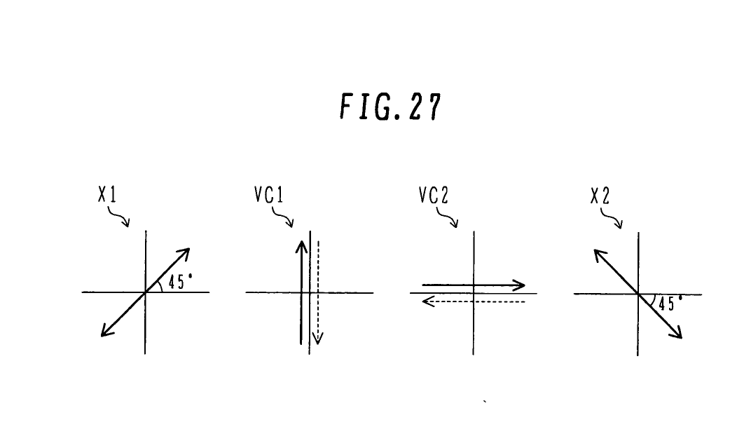

Another display device capable of adopting the present invention may be a projection type display device. FIGS. 26A and 26B show examples of the projection type display device.

The projection type display device shown in FIG. 26A has a structure that a light source LS for emitting parallel light, a polarizer X1, a two-layer structure panel SP, a polarizer X2 and a screen SC are sequentially disposed in this order along a direction of light propagation. The polarizers X1 and X2 are disposed in a crossed-Nicol relation.

The projection type display device shown in FIG. 26B has a structure that a light source LS, e.g., a point light source, a polarizer X1, a two-layer structure panel SP, a polarizer X2, a Fresnel lens FL and a screen SC are sequentially disposed in this order along a direction of light propagation.

With this projection system for projecting an image on the screen SC, an observer can view an optical image projected onto the screen and being generally perpendicular to the substrates so that there is no difference of recognizability between view angles.

The present invention has been described in connection with the embodiments. The present invention is not limited thereto. For example, the liquid crystal cell using the two-layer structure panel SP is not limited to a TN liquid crystal cell, but it is obvious to those skilled in the art that the present invention is also applicable to a vertically aligned type cell, an STN cell, a ferroelectric liquid crystal cell and the like so long as both the liquid crystal cells satisfy the condition that light from the back light is shielded in both the ON and OFF states.

FIG. 27 shows an example of the transmission axes of polarizing plates and the rubbing directions of liquid crystal cells of a display device using vertically aligned liquid crystal cells as the two-layer structure panel. Four coordinate axes correspond, sequentially from the left, to a polarizer X1, a vertically aligned liquid crystal display cell VC1, a vertically aligned liquid crystal display cell VC2 and a polarizer X2. As shown, a rubbing process is performed so that the directions along which liquid crystal molecules fall become perpendicular upon voltage application to the two vertically aligned liquid crystals cells.

If chiral material is added to the liquid crystal cells to make liquid crystal molecules twist while falling upon voltage application, it is set in such a manner that the liquid crystal layers of the liquid crystal cells have the same chiral pitch and opposite twist directions.

Although segment electrodes are used for the display cell, a dot matrix type liquid crystal cell disposing a plurality of pixels (dots) may also be used.

Further, in the embodiments the rigid electrodes f are used for displaying the whole effective display area of the background display cell. The background display cell may have a plurality of display areas. In this case, there are display areas where the liquid crystal molecules are not driven, among the plurality of display areas of the background display cell. In a typical example, these areas are visualized as black display. This black display may be realized by mask printing. Mask printing may use a black mask, or a color matching the peripheral outer ornamental color of the display device may be used.

The present invention has been described in connection with the preferred embodiments. The invention is not limited only to the above embodiments. It will be apparent to those skilled in the art that other various modifications, improvements, combinations, and the like can be made.

What are claimed are:

1. A liquid crystal display device comprising:
a first liquid crystal cell including a first pair of opposing substrates and a first liquid crystal layer held between said first pair of substrates, said first pair of substrates having at least a first pair of pixel electrodes for displaying predetermined characters and figures, and an alignment state of said first liquid crystal layer being capable of being controlled by adjusting a voltage applied across said first pair of pixel electrodes;
a second liquid crystal cell including a second pair of opposing substrates and a second liquid crystal layer held between said second pair of substrates, said second pair of substrates having a second pair of pixel electrodes for completely covering in area said predetermined characters and figures, and an alignment state of said second liquid crystal layer being capable of being controlled by adjusting a voltage applied across said second pair of pixel electrodes;
two cross polarizers disposed on both sides of a two-layer structure panel including said first and second liquid crystal cells along a normal direction of said substrates;
a light source capable of emitting lights of a plurality of colors; and
a control circuit for time sequentially dividing one frame into a plurality of subframes, emitting light of a predetermined color in each subframe, synchronously with light emission, controlling a state of light transmission and light shielding of a plurality of display areas of said two-layer structure panel including said first and second liquid crystal cells,
wherein said first and second liquid crystal cells are structured in a mutual optical compensation relation in both a driving state and a non-driving state.

2. The liquid crystal display device according to claim 1, wherein said control circuit controls in such a manner that said plurality of display areas defined by the electrodes of said first liquid-crystal cell and the electrodes of said second liquid crystal cell take the light transmission state in only one of said subframes or in all said subframes.

3. The liquid crystal display device according to claim 2, wherein if both said first and second liquid crystal cells defining each of said plurality of display areas are in the driving state or non-driving state, each of said display areas enters the light shielding state.

4. The liquid crystal display device according to claim 3, wherein said light source include LED's.

5. The liquid crystal display device according to claim 3, wherein said light source emits parallel light.

6. The liquid crystal display device according to claim 3, wherein said light source is a point light source emitting radiative light.

7. The liquid crystal display device according to claim 1, wherein gradation display is performed by controlling the alignment state of the liquid crystal of at least one of said first and second liquid crystal cells to have an intermediate alignment state between the driving state and non-driving state.

8. The liquid crystal display device according to claim 7, wherein said control circuit controls in such a manner that said plurality of display areas defined by the electrodes of said first liquid crystal cell and the electrodes of said second liquid crystal cell take the light transmission state in only one of said subframes or in all said subframes.

9. The liquid crystal display device according to claim 8, wherein if both said first and second liquid crystal cells defining each of said plurality of display areas are in the driving state or non-driving state, each of said display areas enters the light shielding state.

10. The liquid crystal display device according to claim 9, wherein said light source include LED's.

11. The liquid crystal display device according to claim 9, wherein said light source emits parallel light.

12. The liquid crystal display device according to claim 9, wherein said light source is a point light source emitting radiative light.

13. A driving method for a liquid crystal display device comprising:
a first liquid crystal cell including a first pair of opposing substrates and a first liquid crystal layer held between said first pair of substrates, said first pair of substrates having at least a first pair of pixel electrodes for displaying predetermined characters and figures, and an alignment state of said first liquid crystal layer being capable of being controlled by adjusting a voltage applied across said first pair of pixel electrodes;
a second liquid crystal cell including a second pair of opposing substrates and a second liquid crystal layer held between said second pair of substrates, said second pair of substrates having a second pair of pixel electrodes for completely covering in area said predetermined characters and figures, and an alignment state of said second liquid crystal layer being capable of being controlled by adjusting a voltage applied across said second pair of pixel electrodes;
two cross polarizers disposed on both sides of a two-layer structure panel including said first and second liquid crystal cells along a normal direction of said substrates;
a light source capable of emitting lights of a plurality of colors; and
a control circuit for time sequentially dividing one frame into a plurality of subframes, emitting light of a predetermined color in each subframe, synchronously with light emission, controlling a state of light transmission and light shielding of a plurality of display areas of said two-layer structure panel including said first and second liquid crystal cells,
wherein the driving method controls in such a manner that a display area entered in the light shielding state in a subframe is made to enter in another subframe.

14. The driving method for a liquid crystal display device according to claim 13, wherein:
each frame includes a first subframe and a second subframe;
an emission color of said light source includes a first color and a second color, and
in a display area different from a display area in which said first color transmits in said first subframe, said second color is made to be transmitted in said second subframe.

15. A driving method for a liquid crystal display device comprising:
a first liquid crystal cell including a first pair of opposing substrates and a first liquid crystal layer held between said first pair of substrates, said first pair of substrates having at least a first pair of pixel electrodes for displaying predetermined characters and figures, and an alignment state of said first liquid crystal layer being capable of being controlled by adjusting a voltage applied across said first pair of pixel electrodes;
a second liquid crystal cell including a second pair of opposing substrates and a second liquid crystal layer held between said second pair of substrates, said second pair of substrates having a second pair of pixel electrodes for completely covering in area said predetermined characters and figures, and an alignment state of said second liquid crystal layer being capable of being controlled by adjusting a voltage applied across said second pair of pixel electrodes;
two cross polarizers disposed on both sides of a two-layer structure panel including said first and second liquid crystal cells along a normal direction of said substrates;
a light source capable of emitting lights of a plurality of colors; and
a control circuit for time sequentially dividing one frame into a plurality of subframes, emitting light of a predetermined color in each subframe, synchronously with light emission, controlling a state of light transmission and light shielding of a plurality of display areas of said two-layer structure panel including said first and second liquid crystal cells,
wherein the driving method controls in such a manner that gradation display is performed by controlling the alignment state of the liquid crystal of at least one of said first and second liquid crystal cells to have an intermediate alignment state between the driving state and non-driving state.

16. The driving method for a liquid crystal display device according to claim 15, wherein:
a display area entered in the light transmission state in one subframe is controlled to enter the light shielding state in another subframe;
each frame includes at least a first subframe and a second subframe;
said light source can emit lights of at least a first color and a second color; and
in a display area different from a display area in which said first color transmits in said first subframe, said second color is made to be transmitted in said second subframe.

17. The driving method for a liquid crystal display device according to claim 15, wherein mixed color display is performed by transmitting light of a primary color in each of said subframes and making a display area enter the light transmission state in a plurality of subframes.
